(19) United States
(12) Patent Application Publication
(10) Pub. No.: US 2005/0132684 A1
(43) Pub. Date: Jun. 23, 2005

(54) Wheel for lawnmowers and the like

(76) Inventors: Charles W. Hadaway, Kalamazoo, MI (US); David J. Tarrien, Alto, MI (US); Joseph D. Hadaway JR., Kalamazoo, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/744,514

(22) Filed: Dec. 23, 2003

(51) Int. Cl. A01D 34/03

(52) U.S. Cl. 56/16.7

(57) ABSTRACT

A wheel assembly for use with commercial riding mowers and the like is disclosed. The wheel assembly includes a plastic wheel body having a hub with a pair of bearings positioned within the hub. A plastic or steel spacer is positioned between the wheel bearings, and forms an integral part of the wheel body.

### BACKGROUND OF THE INVENTION

Various types of powered riding lawnmowers have been developed. Such lawnmowers commonly include a deck housing that cover the rotating blades that are used to cut the grass or the like. Such decks are typically movably mounted to the riding mower, and include a housing having a plurality of wheels mounted to the housing to support the deck as it moves across the lawn surface. During use, such wheels encounter objects, and are otherwise subject to substantial wear and tear such that the wheels often need to be replaced in a relatively short period of time.

### SUMMARY OF THE INVENTION

One aspect of the present invention is a wheel assembly including a wheel having a body portion defining opposite sides. The body portion is made of a polymer material, and includes a hub defining a pair of coaxial cylindrical cavities. The cavities have sidewalls defining a first diameter and are open to the opposite sides of the body portion. The hub includes a dividing wall portion between the cylindrical cavities, and the dividing wall portion has an opening therethrough. The wheel assembly further includes first and second bearings positioned in the cavities, and having outer surfaces closely contacting the sidewalls of the cylindrical cavities to thereby retain the bearings in the cylindrical cavities. The first and second bearings preferably include a rolling element.

Another aspect of the present invention is a wheel assembly including a wheel having a body portion defining opposite sides. The body portion is made of a polymer material, and the body portion includes an integral hub defining a pair of cavities having sidewalls. The cavities are open to the opposite sides, and the hub includes an integral dividing portion between the cavities. The wheel assembly further includes first and second roller bearings positioned in the cavities.

Yet another aspect of the present invention is a method of making a wheel assembly. The method includes providing a mold with a mold cavity in the shape of a wheel. First and second bearings are positioned in the mold cavity, and a pre-fabricated spacer is positioned between the bearings to position the bearings in a spaced apart relationship. A plastic material is injected into the mold cavity around the bearings and the spacer to thereby form the wheel assembly.

Yet another aspect to the present invention is a riding lawnmower including a powered main portion configured to support an operator, and a deck assembly operably connected to the main portion. The deck assembly has a housing and at least one powered blade movably mounted on the underside of the housing for cutting grass. The deck includes at least one wheel assembly mounted to the housing via a bracket. The wheel assembly includes a wheel having a body portion including a hub with a pair of spaced apart bearings positioned within the hub. Each bearing includes a rolling element. A pin element is secured to the bracket and extends through the bearing to thereby mount the wheel assembly to the bracket.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially schematic perspective view of a riding lawnmower including a deck with wheel assemblies according to one aspect of the present invention;

FIG. 2 is a cross-sectional view of a prior art wheel assembly;

FIG. 3 is a perspective view of a wheel assembly according to the present invention;

FIG. 4 is a cross-sectional view of the wheel of FIG. 3 taken along the line IV-IV;

FIG. 5 is a perspective view of a spacer;

FIG. 6 is a partially schematic elevational view of an injection mold utilized to fabricate the wheel assembly;

FIG. 7A is a cross-sectional view of the mold of FIG. 6 in the closed position;

FIG. 7B is a cross-sectional view of the mold of FIG. 7A in the open position;

FIG. 8 is a plan view of the mold of FIG. 6;

FIG. 9 is a cross-sectional view of another embodiment of a wheel according to the present invention;

FIG. 10 is a perspective view of a two-piece spacer according to another aspect of the present invention;

FIG. 11 is a partially schematic elevational view of an injection mold utilized to fabricate the wheel assembly of FIG. 9;

FIG. 12 is a cross-sectional view of yet another embodiment of a wheel according to the present invention;

FIG. 13 is a perspective view of a two-piece spacer according to yet another aspect of the present invention, wherein the inner spacer is made of metal; and

FIG. 14 is a partially schematic elevational view of an injection mold utilized to fabricate the wheel assembly of FIG. 12.

### DETAILED DESCRIPTION OF PREFERRED EMBODIMENT

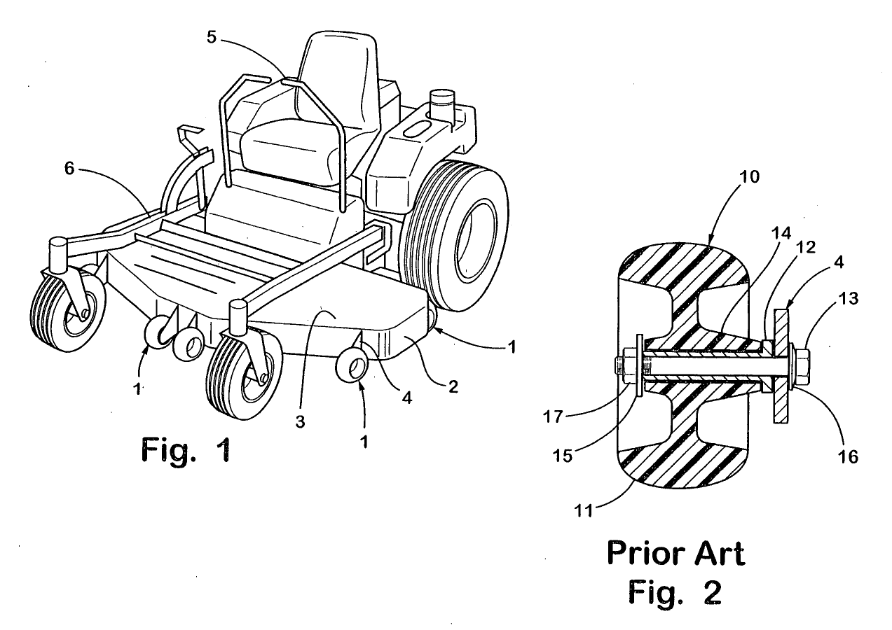

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, the wheel assembly 1 of the present invention mounts to the housing 2 of a mower deck 3 via a plurality of brackets 4. The riding mower 5 includes a mounting structure 6 that supports the deck 3 during operation.

With further reference to FIG. 2, a prior art wheel assembly 10 includes a plastic wheel body 11 mounted to a bracket 4. An elongated bushing 12 extends through the hub 14 of wheel body 11, and a bolt 13, washers 15, 16 and nut 17 secure the wheel body 11 to the bracket 4. The bracket may include a plurality of openings therethrough (not shown) to adjust the height of the wheel assembly 10 to provide for cutting grass to different lengths. In use, the prior art wheel body 11 illustrated in FIG. 2 tends to distort or wear quickly, such that the central opening through the body 11 becomes non-circular. When the wheel body 11 becomes sufficiently deformed, the wheel body 11 will not rotate, thereby hindering proper operation of the lawnmower.

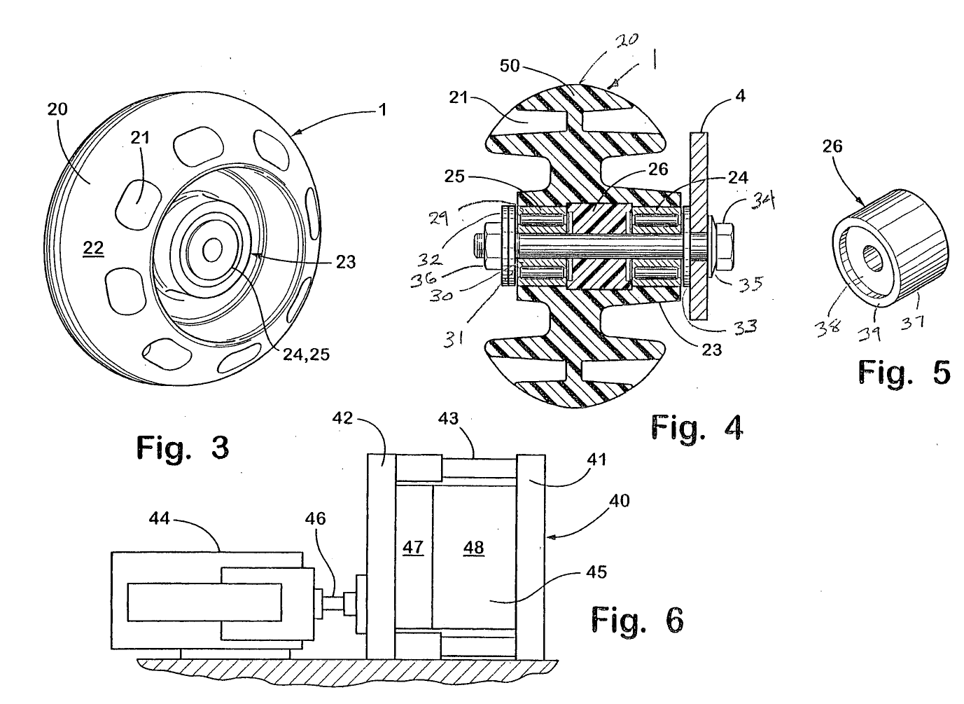

With reference to FIG. 3, the wheel assembly 1 of the present invention includes a wheel body 20 made of a plastic material. The wheel body includes a plurality of cavities 21 that reduce the volume of plastic material required to mold the wheel body 20. The wheel body 20 includes a smoothly curved outer peripheral portion 22 that permits the wheel 1 to slide sideways across the grass surface during mowing. The wheel body 20 includes an integral hub 23 in which bearings 24 and 25 are mounted.

With further reference to FIGS. 4 and 5, a spacer 26 is positioned between the bearings 24 and 25. The hub 23 includes cylindrical cavities 27 and 28 that receive the bearings 24 and 25. The bearings 24 and 25 are commercially available roller bearings having an outer race 29 and an inner race 30. Inner races 30 include an outer side surface 31 that contacts washers 32 and 33 when the wheel assembly 1 is connected to a bracket 4. An elongated bolt 34, lock washer 35, and nut 36 secure the wheel assembly 1 to the bracket 4.

With reference to FIG. 5, the spacer 26 has a generally cylindrical outer surface 37, and recessed end portions 38 forming an annular lip 39. As illustrated in FIG. 4, the diameter of the cylindrical surface 37 of spacer 26 is somewhat greater than the diameter of the outer races 29 of bearings 24 and 25. As discussed in more detail below, this arrangement prevents plastic material from entering the bearings 24 and 25 between the outer races and inner races 29 and 30 during fabrication of the wheel assembly. Also, for clarity the spacer 26 is shown as being a separate part in FIG. 4. However, during manufacture the spacer 26 melts and fuses to the plastic of the wheel body 20, thereby forming a substantially one-piece plastic part.

With further reference to FIG. 6, an injection mold 40 includes mold platens that are movably interconnected by guide rods 43 in a known manner, and plastic injection mold machine 44 feeds melted plastic into the mold 45 via screws 46 in a conventional manner. The mold 45 includes a first mold part or half 47, and a second mold half or part 48.

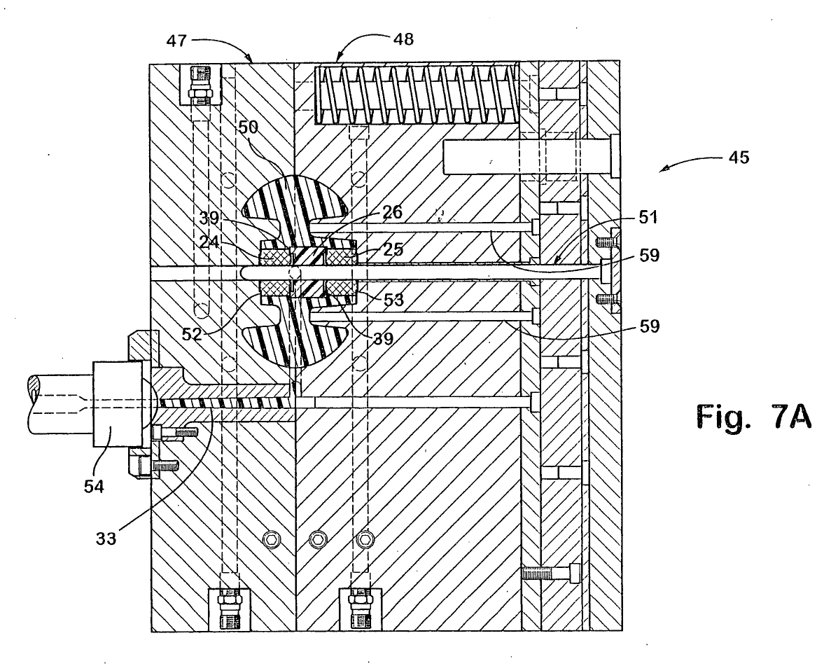

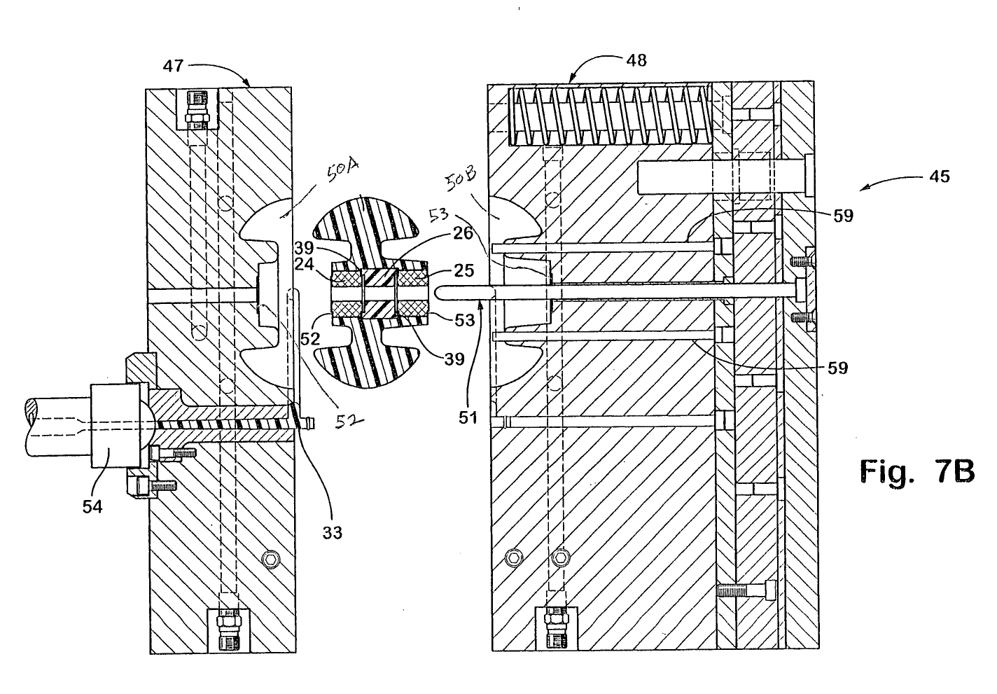

With further reference to FIGS. 7A and 7B, the mold 45 includes a mold cavity 50 formed by cavity halves 50A and 50B in the mold parts 47 and 48, respectively. An elongated support pin 51 extends at least partly into the mold cavity 50. During fabrication, bearings 24 and 25 are positioned on the support pin with the spacer 25 therebetween prior to injection of the plastic material into the mold cavity 50. Mold parts 47 and 48 include annular engagement surfaces 52 and 53, respectively that contact the bearings 24 and 25 when the mold parts 47 and 48 are in the closed position illustrated in FIG. 7. In a preferred embodiment, the distance between the surfaces 52 and 53 when the mold is closed is slightly less than the overall length of the bearings 24 and 25 and spacer 26. When the mold parts 47 and 48 are shifted to the closed position, the spacer 26 is compressed slightly to ensure that the annular lips or surfaces 39 of spacer 26 seal against the outer races 29 of the bearings 24 and 25, and also to ensure that the engagement surfaces 52 and 53 also engage the peripheral side edges of the outer races of the bearings 24 and 25. This ensures that the plastic material injected into the mold cavity 50 does not flow around the outer races of the bearings 24 and 25 and enter the bearings themselves.

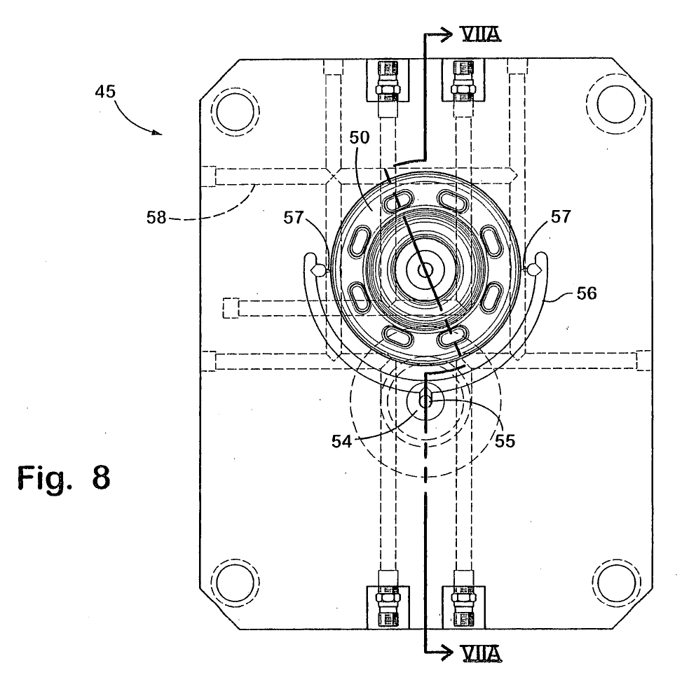

The plastic material is injected into the mold 45 through a screw 54 that is connected to a passageway 55. As illustrated in FIG. 8, passageway 55 connects to a C-shaped passageway 56 that extends around the mold cavity 50. Gates 57 are in fluid communication with passageway 56, and inject plastic through opposite peripheral portions of the mold cavity 50 to thereby ensure that the plastic flows through the mold cavity 50 in a uniform manner. The mold assembly 45 also includes a plurality of hot water passages 58, and ejector pins 59 that are of a conventional design. These conventional components are known to those skilled in the art, and will therefore not be described in more detail herein.

During operation, the mold halves 47 and 48 are first separated. An operator then places the bearings 24 and 25 on the support pin 51, with the spacer 26 positioned between the bearings 24 and 25. The support pin 51 is preferably horizontally positioned such that the bearings 24, 25 and spacer 26 do not slide on pin 51. The mold halves or parts 47 and 48 are then closed, and molten plastic is injected into the mold cavity 50. The spacer 26 is preferably made of substantially the same plastic material as the plastic injected into the mold cavity 50, such that the spacer 26 becomes fused with the other plastic material to form an integral, one piece plastic wheel body portion. Because the plastic flows around the outer surfaces of bearings 24 and 25, the plastic material contacts the bearings 24 and 25 and thereby retains the bearings 24 and 25 within the wheel assembly 1.

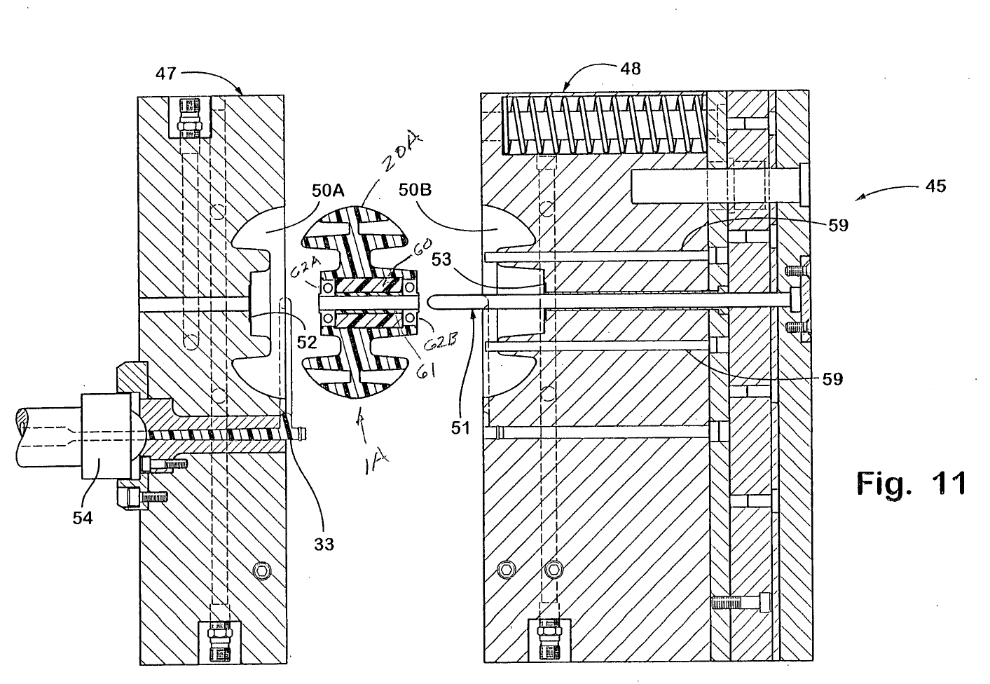

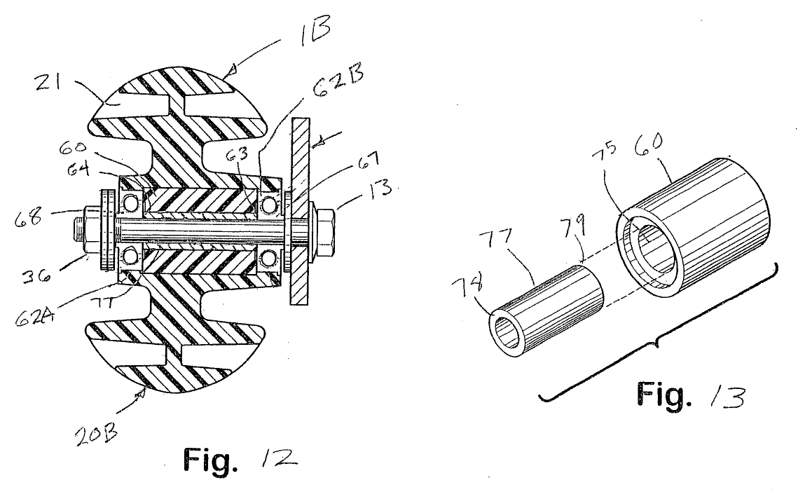

A second embodiment 1A of a wheel assembly according to the present invention is similar to the wheel 1 of FIG. 4, except that a two-piece spacer including a first or outer spacer 60 and a second or inner spacer 61 (see also FIG. 10) is utilized. Also, ball bearings 62A and 62B are utilized rather than the roller bearings 24 and 25. The length of the spacer 61 is selected such that the end surfaces 65 and 66 thereof fit tightly against the inner surfaces 63 and 64 of inner races 67 and 68 of ball bearings 62A and 62B when assembled on the elongated support pin 51 (see also FIG. 11) and the mold parts 47 and 48 are closed. The contact between the inner spacer 61 and the inner races 67 and 68 ensures that molten plastic material cannot enter the ball bearings 62A and 62B during assembly. Similarly, the end surfaces 71 and 72 contact the outer races 69 and 70 to ensure that molten plastic does not flow into the ball bearings 62A and 62B.

During assembly, the ball bearings 62A and 62B are placed on the elongated support pin 51 with the spacers 60 and 61 positioned between the bearings 62A and 62B. The overall dimensions of the mold cavity 50A are chosen such that the engagement surfaces 52 and 53 contact the ball bearings 62A and 62B, respectively, when the mold is closed, and the spacers 60 and 61 are compressed slightly to ensure that the spacers seal against the races of the ball bearings 62A and 62B. When the mold is closed, molten plastic is injected into the mold cavity 50 around the ball bearings 62A and 62B, and the spacers 60 and 61. During fabrication, the molten plastic material flows around the outer surfaces 73 and 74 of outer races 69 and 70 to thereby form a tight fit that retains the ball bearings 62A and 62B in the wheel body 20A. For purposes of illustration, the plastic wheel body 20A and spacer 60 is illustrated as being a separate piece. However, it should be understood that when the molten plastic is injected into the mold cavity 50, the spacer 60 melts and form a substantially integral one-piece plastic unit with the wheel body. Despite the melting of the spacer 60, the spacer still provides sufficient sealing against the ball bearings 62A and 62B to prevent entry of the molten plastic into the ball bearings. A small amount of clearance is provided between the spacers 60 and 61, such that inner spacer 61 does not melt or fuse to spacer 60. In use, inner spacer 61 remains stationary due to the contact with inner races of the ball bearings 62A and 62B. After the plastic has solidified, the mold parts 47 and 48 are shifted apart, and the wheel assembly 1A is removed.

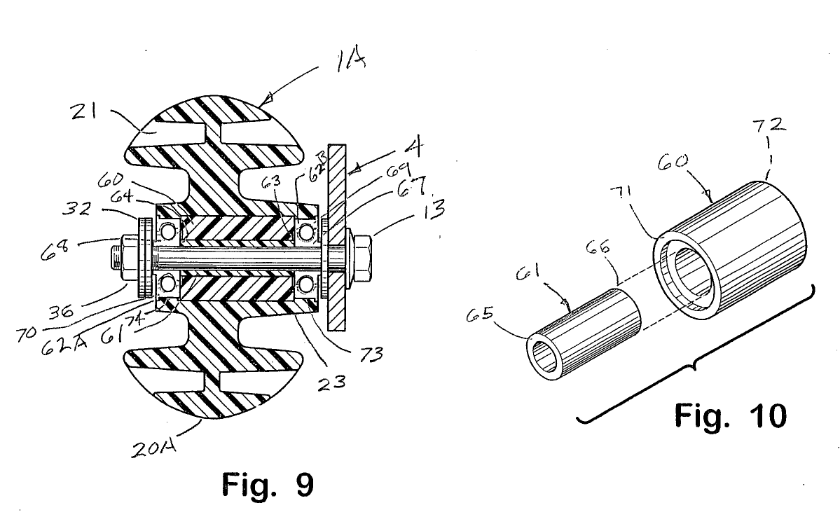

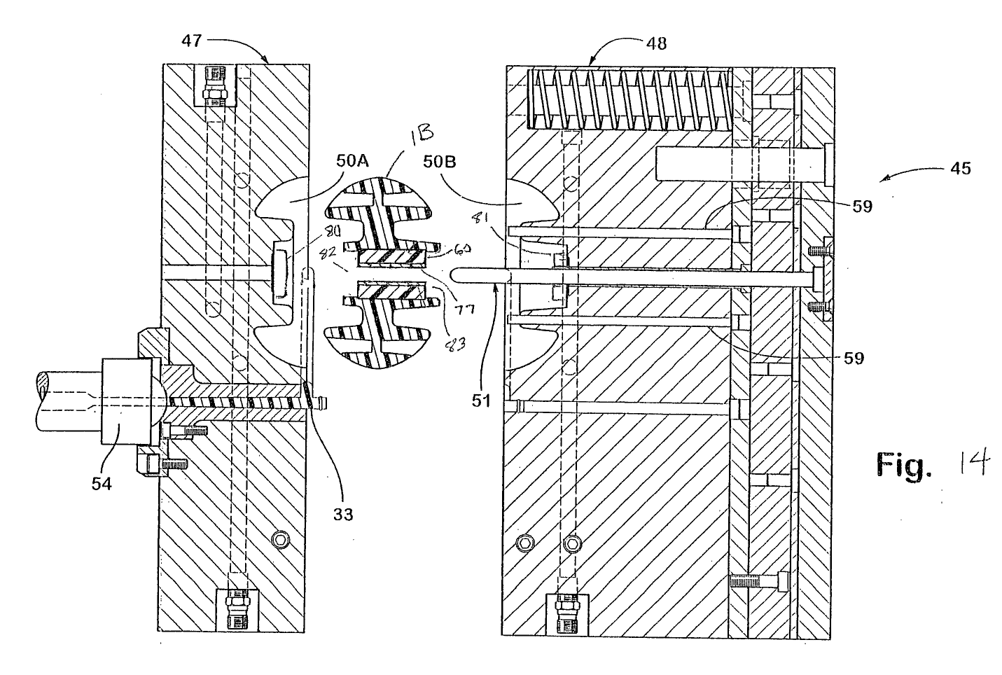

Yet another embodiment 1B or the wheel assembly is illustrated in FIG. 12. The wheel assembly 1B is substantially similar to the wheel assembly 1A of FIG. 9, except that the inner spacer 77 (see also FIG. 13) is made of a metal material and has an inner diameter that is slightly greater than that of the shaft of the bolt 13. Also, as described in more detail below, during fabrication of the wheel 1B, cavities for receiving ball bearings 62A and 62B are molded into the hub of the polymeric wheel body 20B, and the ball bearings 62A and 62B are press fit into the cavities with the inner surfaces 63 and 64 of the inner races 67 and 68 tightly engaging the ends 78 and 79 of metal inner spacer 77. The outer diameter of inner spacer 77 is somewhat smaller than the diameter of the opening 75 through the outer spacer 60, such that the spacer 77 can turn freely with respect to the outer spacer 60. In operation, the tight fit between the inner spacer 77 and the inner races of the ball bearings 62A and 62B causes inner spacer 77 to be fixed relative to the inner races 67 and 68, such that the inner spacer 77 rotates relative to the polymeric wheel body 20B. When assembled (FIG. 12) the axial force generated by the bolt 13 and nut 36 is reacted through the inner races of the ball bearings and through the steel or metal inner spacer 77 to prevent crushing of the polymeric portions of the wheel body 1B.

With further reference to FIG. 14, during a first method of fabrication, a ball bearing 62B (not shown in FIG. 14) may be placed on the support rod 51, and the larger, polymer outer sleeve 60 and inner metal sleeve 77 are also placed on the support rod 51. A second bearing is then placed on the support rod 51, with the sleeves 60 and 77 positioned between the two bearings. The first and second mold parts 47 and 48 are then closed, and the mold cavity is filled with molten plastic in a manner that is substantially similar to the method described in more detail above.

Alternately, in a second fabrication method first and second “plugs” or cores 80 and 81 are secured within the mold cavity by conventional fasteners or the like (not shown). The plugs 80 and 81 have substantially the same size and shape as the ball bearings 62A and 62B. During fabrication utilizing the second method, the inner metal sleeve 77 and outer polymer sleeve 60 are placed on the rod 51, and the mold parts 47 and 48 are closed. The mold cavity is then filled with molten plastic metal. The plugs 80 and 81 form cavities 82 and 83 adjacent opposite ends of the spacers 60 and 77. The bearings 62A and 62B are then press fit into the cavities 82 and 83 with the inner surfaces 63 and 64 of the bearings tightly abutting the ends 78 and 79 of the inner metal spacer 77. In a preferred embodiment, the outer diameter of the plugs 80 and 81 is somewhat less than the outer diameter of the bearings 62A and 62B, such that a tight press fit is formed when the bearings are installed. As discussed above, the inner diameter of the spacer 60 is somewhat larger than the outer diameter of the spacer 77, such that the spacer 77 turns freely with respect to the wheel body 1B formed by the molten metal injected into the mold cavity that melts with and becomes integral with the plastic outer spacer 60.

The wheel assembly of the present invention provides a pair of spaced apart wheel bearings that react moments caused by sideways sliding of the wheel during use. Furthermore, the integral spacers position the bearings during the fabrication process, and also ensures that plastic does not enter the bearings themselves in a manner that would otherwise impede proper operation of the bearings. Still further, the bearings of the present wheel assembly reduce rolling friction, thereby improving the operation of the riding mower.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A wheel assembly, comprising:
a wheel having a body portion defining opposite sides, said body portion made of a polymer material, said body portion including a hub defining a pair of coaxial cylindrical cavities having sidewalls defining a first diameter and opening to said opposite sides, said hub including a dividing wall portion between said cylindrical cavities, said dividing wall portion having an opening therethrough; and:
first and second bearings positioned in said cavities and having outer surfaces closely contacting said sidewalls of said cylindrical cavities to thereby retain said bearings in said cylindrical cavities, said first and second bearings including a rolling element.

2. The wheel assembly of claim 1, wherein:
said first and second bearings include inner and outer races and a plurality of rolling elements disposed between said inner and outer races, said inner races having a protruding circular end surface configured to engage a washer to axially retain said wheel assembly.

3. The wheel assembly of claim 2, wherein:
said dividing wall portion includes first annular lips in each cavity engaging said outer races and second annular lips engaging said inner races to position said bearings in said cylindrical cavities.

4. The wheel assembly of claim 3, wherein:
said circular end surface of said first bearing protrudes beyond a selected one of said opposite sides of said body portion.

5. The wheel assembly of claim 4, wherein:
said body portion defines a peripheral outer surface and a center plane coincident with a maximum diameter portion of said peripheral outer surface, said dividing wall portion offset relative to said center plane.

6. A wheel assembly, comprising:
a wheel having a body portion defining opposite sides, said body portion made of a polymer material, said body portion including an integral hub defining a pair of cavities having sidewalls, said cavities opening to said opposite sides, said hub including an integral dividing portion between said cavities, said dividing portion having an opening therethrough and defining oppositely facing side surfaces;
a metal sleeve rotatably disposed in said opening with opposite ends of said sleeve disposed adjacent said oppositely facing side surfaces;
first and second ball bearings positioned in said cavities, each ball bearing having an inner race abutting opposite ends of said sleeve.

7-15. (canceled)

16. A riding lawnmower, comprising:
a powered main portion configured to support an operator;
a deck assembly operably connected to said main portion having a housing and at least one powered blade movably mounted on the underside of the housing for cutting grass; said deck including at least one bracket adapted to mount a wheel to said housing;
a wheel assembly mounted to said bracket, said wheel assembly including a wheel having a body portion including a hub with a pair of spaced apart bearings positioned within said hub, each bearing including a roller element;
a pin element secured to said bracket and extending through said bearings to thereby mount said wheel assembly to said bracket.

17. The riding lawnmower of claim 15, wherein:
said body portion of said wheel includes a dividing wall portion forming an integral spacer between said bearings.

18. The riding lawnmower of claim 17, wherein:
said wheel assembly defines opposite sides;
said hub defines coaxial cylindrical cavities opening oppositely outwardly towards said opposite sides;
said bearings are positioned within said cylindrical cavities.

19. The riding lawnmower of claim 18, wherein:
said first and second bearings include inner and outer races and a plurality of rolling elements disposed between said inner and outer races, said inner races having a protruding circular end surface configured to engage a washer to axially retain said wheel assembly.

20. The riding lawnmower of claim 19, wherein:
said dividing wall portion includes annular lips in each cavity engaging said outer races to position said bearings in said cylindrical cavities.

21. The riding lawnmower of claim 20, wherein:
said circular end surface of said first bearing protrudes beyond a selected one of said opposite sides of said body portion.

22. The riding lawnmower of claim 21, wherein:
said body portion defines a peripheral outer surface and a center plan coincident with a maximum diameter ring portion of said peripheral outer surface, said dividing wall portion offset relative to said center plane.

23. (canceled)

24. The wheel assembly of claim 1, wherein:
the first and second bearings are press fit into the body portion, thereby creating hoop stress in the sidewalls of the cavities.

25. The wheel assembly of claim 6, wherein:
each ball bearing includes an outer race that abuts the oppositely facing side surfaces.

26. The wheel assembly of claim 6, wherein:
the sidewalls of the cavities have a cylindrical shape.
